(19) United States
(12) Patent Application Publication
(10) Pub. No.: US 2012/0019454 A1
(43) Pub. Date: Jan. 26, 2012

(54) Driving Method, Driving Device and Touch Sensitive Display Device Using the Same

(76) Inventor: Chiu-Huang Huang, Hsinchu County (TW)

(21) Appl. No.: 12/903,210

(22) Filed: Oct. 13, 2010

(30) Foreign Application Priority Data
Jul. 20, 2010 (TW) 099123856

(51) Int. Cl. G06F 3/041

(52) U.S. Cl. 345/173

(57) ABSTRACT

A driving method for driving a touch sensitive display device which includes a substrate, a plurality of pixel units, a touch panel and a plurality of touch sensors, and displays a frame of a video and detects at least one touch point per vertical scanning period is disclosed. The driving method includes generating a plurality of touch scanning impulses in a non-display period of the vertical period, detecting the at least one touch point according to the plurality of touch scanning impulses in the non-display period, generating a plurality of scanning impulses according to a synchronization signal in a display period of the vertical scanning period to indicate a frame updating sequence of the plurality of pixel units, and generating a plurality of source driving signals according to frame data in the display period to indicate color intensities of the plurality of pixel units.

### BACKGROUND OF THE INVENTION

1. Field of the Invention

The present invention is related to a driving method, driving device and touch sensitive display device using the same, and more particularly, to a driving method, driving device and touch sensitive display device using the same which detect a touch point in a non-display period.

2. Description of the Prior Art

With advances in manufacturing technology, a touch panel and a display panel are successfully integrated in an electronic device to enable a user to directly indicate desired tasks by touching the electronic device. In general, pixel units of the display panel and touch sensors of the touch panel are both arranged in two-dimensional matrixes, and sequences for updating frame data and detecting a touch point are determined based on scanning signals.

Please refer to FIG. 1, which is a schematic diagram of a touch sensitive display device 10 of the prior art. The touch sensitive display device 10 includes a display panel 100, a touch panel 110, a source driver 120, a gate driver 130, a touch processor 140 and a touch driver 150. The display panel 100 includes pixel units 102 arranged in a two-dimensional matrix. Similarly, the touch panel 110 includes touch sensors 112 arranged in a two-dimensional matrix. The source driver 120 generates source driving signals VS_1-VS_M according to an image signal FRM to indicate color intensities of the pixel units 102. The gate driver 130 generates scanning impulses VG_1-VG_N according to a synchronization signal SEQ to indicate an updating sequence of the pixel units 102. Meanwhile, the touch driver 150 generates touch scanning impulses VTS_1-VTS_J to trigger the touch sensors 112. Since contact with the touch sensors 112 results in capacitance or resistance variations thereof, response impulses generated by the touched touch sensors 112 are distinctive from response impulses generated by the untouched touch sensors 112. As a result, the touch processor 140 can determine which one of the touch sensors 112 the touch point is located on based on voltage variations of the response impulses VR_1-VR_K.

Since the touch panel 110 is closely stacked onto the display panel 100, voltage variations of the scanning impulses VG_1-VG_N and the source driving signals VS_1-VS_M easily couple into the touch sensors 112, resulting in erroneous determination of the touch point. In other words, since the pixel units 102 and the touch sensors 112 operate at the same time, and the touch sensors 112 are more sensitive than the pixel units 102, the touch sensors 112 are susceptible to noise generated by the scanning impulses VG_1-VG_N and the source driving signals VS_1-VS_M, and therefore generate the response impulses VR_1-VR_K with biases.

Therefore, reducing disturbances in the display panel on the touch sensors has been a major focus of the industry.

### SUMMARY OF THE INVENTION

It is therefore a primary objective of the claimed invention to provide a driving method, driving device and touch sensitive display device using the same.

The present invention discloses a driving method for driving a touch sensitive display device. The touch sensitive display device comprises a substrate, a plurality of pixel units, a touch panel and a plurality of touch sensors, displays a frame of a video, and detects at least one touch point per vertical scanning period. The driving method comprises generating a plurality of touch scanning impulses in a non-display period of the vertical scanning period to trigger the plurality of touch sensors, detecting the at least one touch point according to the plurality of touch scanning impulses in the non-display period to generate a plurality of response impulses, generating a plurality of scanning impulses according to a synchronization signal in a display period of the vertical scanning period to indicate a frame updating sequence of the plurality of pixel units, and generating a plurality of source driving signals according to frame data in the display period to indicate color intensities of the plurality of pixel units.

The present invention further discloses a driving device for driving a touch sensitive display device. The touch sensitive display device comprises a substrate, a plurality of pixel units, a touch panel and a plurality of touch sensors, displays a frame of a video, and detects at least one touch point per vertical scanning period. The driving device comprises a display driving module comprising a gate driver coupled to the plurality of pixel units for generating a plurality of scanning impulses according to a synchronization signal in a display period of the vertical scanning period to indicate a frame updating sequence of the plurality of pixel units, a source driver coupled to the plurality of pixel units for generating a plurality of source driving signals according to frame data in the display period to indicate color intensities of the plurality of pixel units, and a controller for generating an activation signal to indicate a non-display period of the vertical scanning period, and a touch driver coupled to the controller and the plurality of touch sensors for generating a plurality of touch scanning impulses according to the activation signal in the non-display period to trigger the plurality of touch sensors.

The present invention further discloses a touch sensitive display device for displaying a frame of a video and detecting at least one touch point per vertical scanning period. The touch sensitive display device comprises a panel module comprising a display panel comprising a substrate, and a plurality of pixel units arranged as a first matrix on the substrate, each corresponding to an element of the first matrix, and a touch panel stacked upon the display panel comprising a plurality of touch sensors arranged as a second matrix for detecting the at least one touch point according to the plurality of touch scanning impulses in a non-display period of the vertical scanning period to generate a plurality of response impulses, and a driving device comprising a display driving module comprising a gate driver coupled to the plurality of pixel units for generating a plurality of scanning impulses according to a synchronization signal in a display period of the vertical scanning period to indicate a frame updating sequence of the plurality of pixel units, a source driver coupled to the plurality of pixel units for generating a plurality of source driving signals according to frame data in the display period to indicate color intensities of the plurality of pixel units, and a controller for generating an activation signal to indicate the non-display period, and a touch driver coupled to the controller and the plurality of touch sensors for generating the plurality of touch scanning impulses according to the activation signal in the non-display period to trigger the plurality of touch sensors.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a touch sensitive display device of the prior art.

FIG. 2 is a schematic diagram of a touch sensitive display device according to an embodiment of the present invention.

FIG. 3A, FIG. 3B and FIG. 3C are timing diagrams of the touch sensitive display device shown in FIG. 2.

FIG. 4 is a schematic diagram of a driving process according to an embodiment of the present invention.

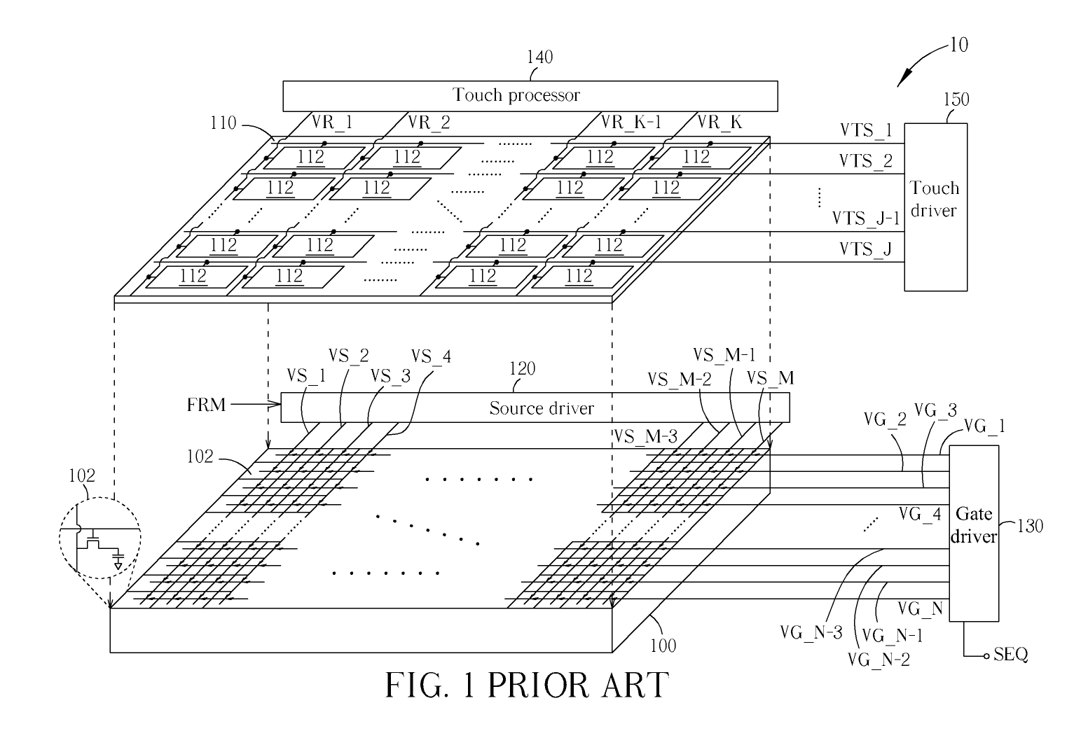

### DETAILED DESCRIPTION

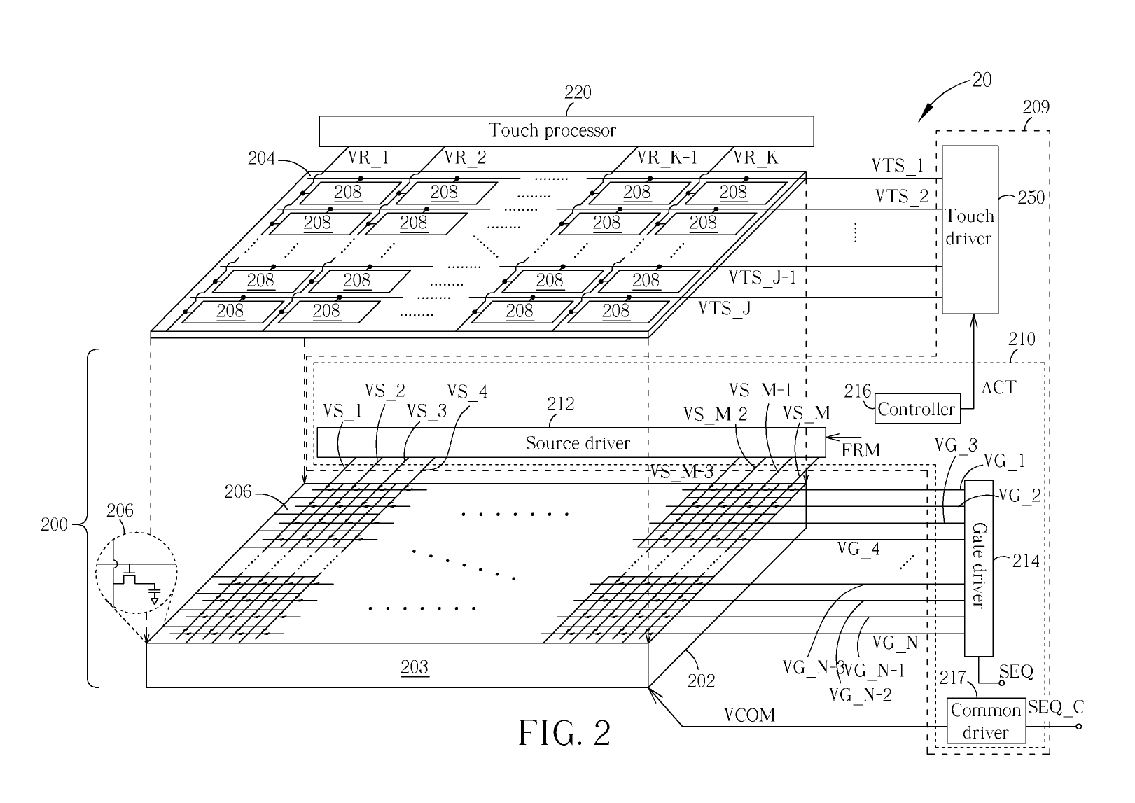

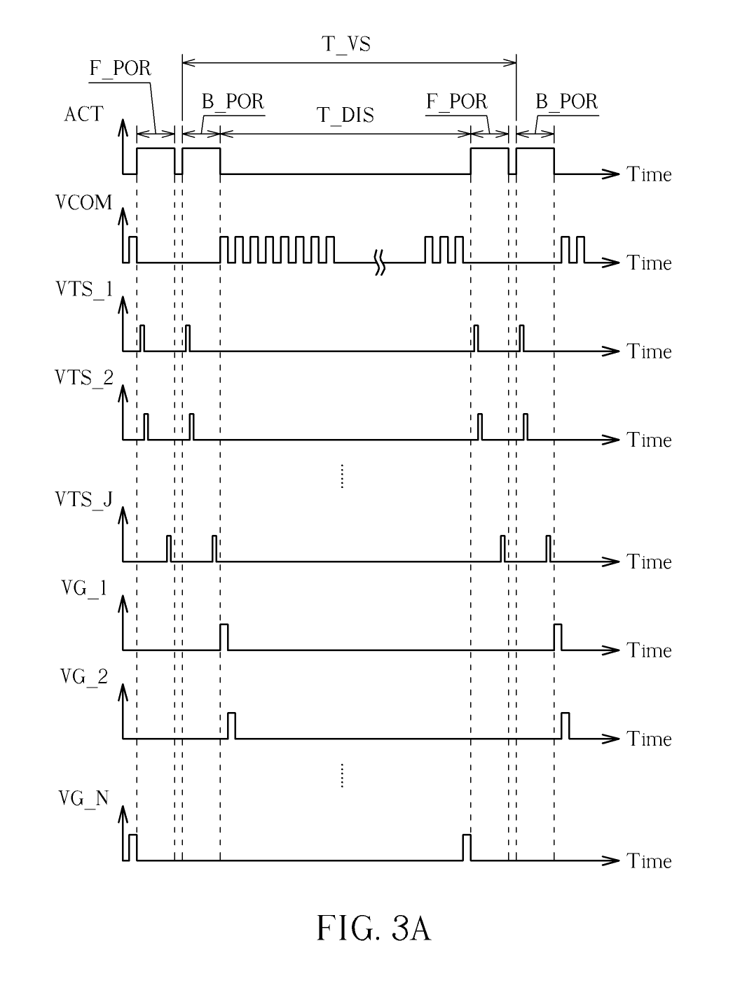

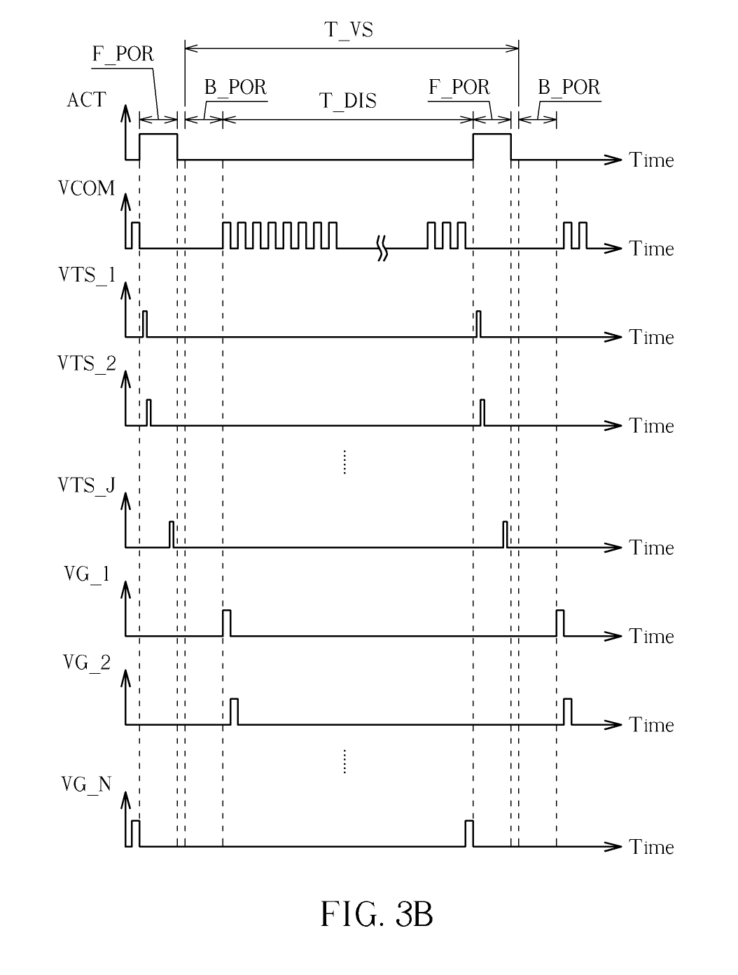

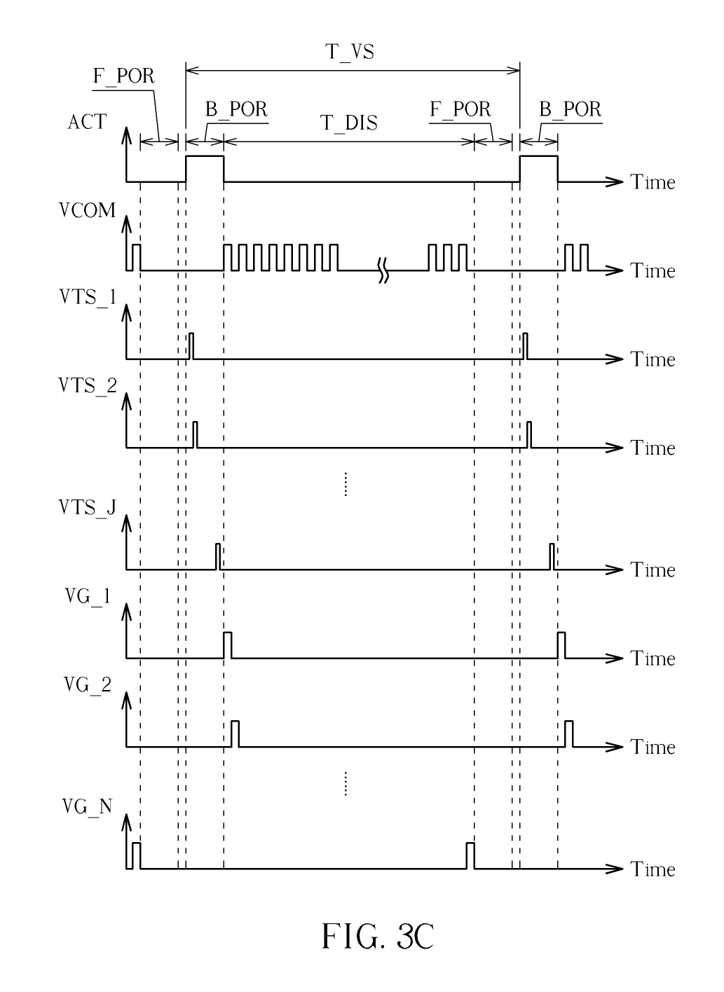

Please refer to FIG. 2, which is a schematic diagram of a touch sensitive display device 20 according to an embodiment of the present invention. As the name implies, the touch sensitive display device 20 performs display and touch functions at the same time. The touch sensitive display device 20 displays a frame of a video and detects one or multiple touch points per vertical scanning period. The touch sensitive display device 20 includes a panel module 200, a driving device 209 and a touch processor 220. The panel module 200 includes a display panel 202 and a touch panel 204. The display panel 202 is utilized for displaying images, and includes a substrate 203 and pixel units 206 arranged in a matrix. The touch panel 204 includes touch sensors 208 also arranged in a matrix for sensing one or multiple touch points created by a finger or an object according to sensor scanning impulses VTS_1-VTS_J to generate response impulses VR_1-VR_K. To simultaneously drive the pixel units 206 and the touch sensors 208, the driving device 209 includes a display driving module 210 and a touch driver 250. The display driving module 210 controls display contents and updating timing of the pixel units 206, and includes a source driver 212, a gate driver 214, a controller 216 and a common driver 217. The controller 216 is utilized for generating an activation signal ACT to indicate a non-display period of the vertical scanning period. The touch driver 250 is utilized for generating touch scanning impulses VTS_1-VTS_J according to the activation signal ACT during the non-display period to trigger the touch sensors 208, as illustrated in FIG. 3A, FIG. 3B and FIG. 3C. Inversely, the gate driver 214 generates scanning impulses VG_1-VG_N according to a synchronization signal SEQ during a display period T_DIS of the vertical scanning period T_VS to indicate a frame updating sequence of the pixel units 206. Correspondingly, the source driver 212 generates source driving signals VS_1-VS_M according to an image signal FRM during the display period T_DIS to indicate color intensities of the pixel units 206. The common driver 217 is utilized for providing a common voltage VCOM sent to the substrate 203 according to a common synchronization signal SEQ_C. Finally, the touch processor 220 determines the touch point according to voltage variations and timing of the response impulses VR_1-VR_K.

In short, to prevent the touch sensors 208 from experiencing interference by noise generated by the scanning impulses VG_1-VG_N and the source driving signals VS_1-VS_M, the touch sensitive display device 20 detects the touch point during the non-display period. As a result, even if voltage disturbances from the display driving module 210 couple into the touch panel 204, the touch sensors 208 do not operate and therefore are not influenced.

As illustrated in FIG. 3A, FIG. 3B and FIG. 3C, the non-display period is divided into a forward edge period F_POR and a backward edge period B_POR, respectively located in late and early edges of the display period T_DIS. In FIG. 3A, the touch driver 250 generates the touch scanning impulses VTS_1-VTS_J in both the forward edge period F_POR and the backward edge period B_POR. That is, the touch sensitive display device 20 updates the frame data once and detects the touch point twice per vertical scanning period T_VS. Certainly, the touch driver 250 can generate the touch scanning impulses VTS_1-VTS_J in either the forward edge period F_POR or the backward edge period B_POR, as illustrated in FIG. 3B and FIG. 3C. In this case, the touch sensitive display device 20 detects the touch point once per vertical scanning period T_VS.

Note that, conventional frame inversion, line inversion or dot inversion techniques can be applied to the driving device 209 and the display panel 202 to periodically invert polarities of the pixel units 206 and therefore guarantee that the pixel units 206 are constantly sensitive to image data variations. In general, inversion operations are implemented by inverting the source driving signals VS_1-VS_M or inverting both the source driving signals VS_1-VS_M and the common voltage VCOM. However, since the substrate 203 has a giant plane area and stores a lot of charge relative to the touch sensors 208, inverting the common voltage VCOM generates voltage disturbances significant to the touch sensors 208, resulting in erroneous determination for the touch point. To minimize the voltage disturbances in the display panel 202, the touch sensitive display device 20 preferably maintains the common voltage VCOM as a constant during the non-display period, as illustrated in FIG. 3A, FIG. 3B and FIG. 3C. Note that, the scanning impulses VG_1-VG_N and the source driving signals VS_1-VS_M are also constant during the non-display period.

In FIG. 3A, FIG. 3B and FIG. 3C, the forward edge period F_POR and the backward edge period B_POR are merely minor parts of the vertical scanning period T_VS. That is, since time allowable for transmitting the touch scanning impulses VTS_1-VTS_J is limited during the vertical scanning period T_VS, a number J of the touch scanning impulses VTS_1-VTS_J is limited as well. For the touch sensitive display device 20 designed according to a stacked structure, a plane density of the touch sensors 208 is lower than a plane density of the pixel units 206. For that reason, the number J of the touch scanning impulses VTS_1-VTS_J is less than a number N of the scanning impulses VG_1-VG_N. That is, the innovative idea of “versatile usage” of the non-display period is preferably applicable to the stacked structure of the touch sensitive display device. If a touch sensitive display device is designed according to an embedded structure in which all the touch sensors 208 are embedded within the touch sensors 206, the plane densities of the touch sensors 208 and the pixel units 206 are equal, and it is difficult for the touch driver 250 to finish scanning the touch panel 204 in merely the non-display period. Certainly, if not all of the touch sensors 208 are embedded within the pixel units 206, or the touch driver 250 scans the touch panel 204 based on a low scanning frequency, the innovative idea of “versatile usage” of the non-display period is still applicable to the embedded structure of the touch sensitive display device.

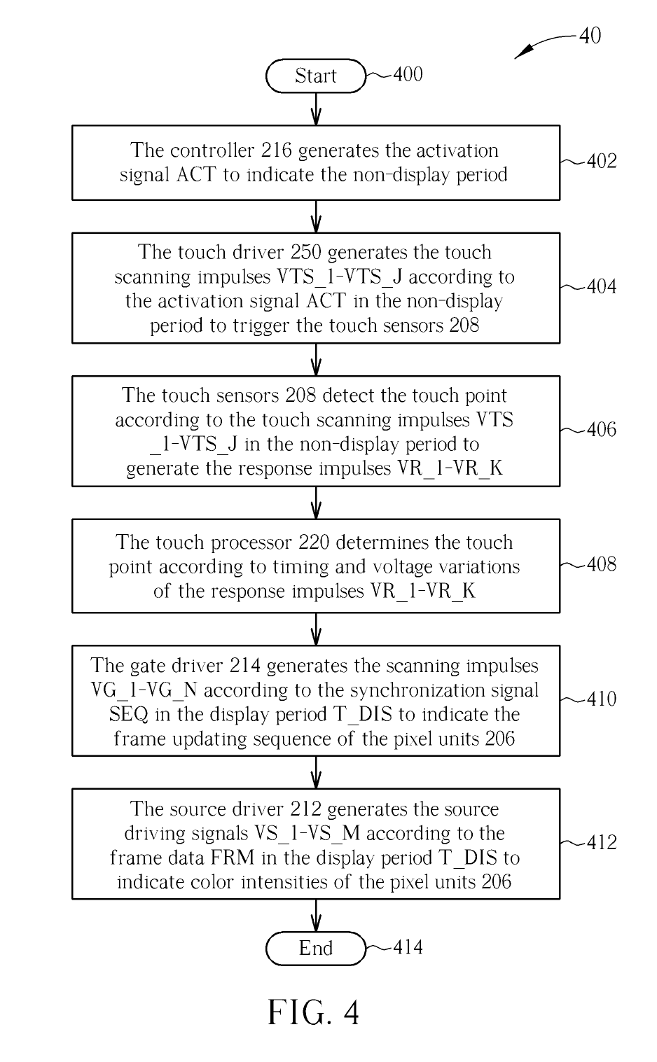

Operations of the touch sensitive display device 20 can be summarized into a driving process 40, as illustrated in FIG. 4. The driving process 40 includes the following steps:

Step 400: Start.

Step 402: The controller 216 generates the activation signal ACT to indicate the non-display period.

Step 404: The touch driver 250 generates the touch scanning impulses VTS_1-VTS_J according to the activation signal ACT in the non-display period to trigger the touch sensors 208.

Step 406: The touch sensors 208 detect the touch point according to the touch scanning impulses VTS_1-VTS_J in the non-display period to generate the response impulses VR_1-VR_K.

Step 408: The touch processor 220 determines the touch point according to timing and voltage variations of the response impulses VR_1-VR_K.

Step 410: The gate driver 214 generates the scanning impulses VG_1-VG_N according to the synchronization signal SEQ in the display period T_DIS to indicate the frame updating sequence of the pixel units 206.

Step 412: The source driver 212 generates the source driving signals VS_1-VS_M according to the frame data FRM in the display period T_DIS to indicate color intensities of the pixel units 206.

Step 414: End.

Details of the driving process 40 can be referred in the above, and are not further narrated herein.

In the prior art, the touch sensitive display device 10 simultaneously detects the touch point and updates the image content. As a result, voltage variations of the scanning impulses VG_1-VG_N and the source driving signals VS_1-VS_M utilized for updating the image content couple into the touch sensors 112, resulting in erroneous determination of the touch point. In comparison, the forward edge period F_POR and the backward edge period B_POR are further utilized for detecting the touch point according to the present invention. As a result, operating periods of the touch sensors 208 and the pixel units 206 are staggered, and therefore the touch point can be correctly detected without employing additional control and calibration circuits.

To sum up, the present invention further utilizes the forward edge period and the backward edge period of the vertical scanning period for detecting the touch point to stagger operating timings of the touch sensors and the pixel units and prevent the touch sensors from being interfered with by display noise.

Those skilled in the art will readily observe that numerous modifications and alterations of the device and method may be made while retaining the teachings of the invention.

What is claimed is:

1. A driving method for driving a touch sensitive display device, the touch sensitive display device comprising a substrate, a plurality of pixel units, a touch panel and a plurality of touch sensors, displaying a frame of a video and detecting at least one touch point per vertical scanning period, the driving method comprising:
generating a plurality of touch scanning impulses in a non-display period of the vertical scanning period to trigger the plurality of touch sensors;
detecting the at least one touch point according to the plurality of touch scanning impulses in the non-display period to generate a plurality of response impulses;
generating a plurality of scanning impulses according to a synchronization signal in a display period of the vertical scanning period to indicate a frame updating sequence of the plurality of pixel units; and
generating a plurality of source driving signals according to frame data in the display period to indicate color intensities of the plurality of pixel units.

2. The driving method of claim 1, wherein the non-display period is a forward edge period of the vertical scanning period, a backward edge period of the vertical scanning period or a union of the forward edge period and the backward edge period.

3. The driving method of claim 1 further comprising:
providing a common voltage sent to the substrate according to a common synchronization signal, wherein the common voltage is constant in the non-display period; and
determining the at least one touch point according to the plurality of response impulses.

4. The driving method of claim 1, wherein the plurality of pixel units are arranged as a first matrix on the substrate, and the plurality of touch sensors are arranged as a second matrix on the touch panel.

5. The driving method of claim 1, wherein the plurality of scanning impulses and the plurality of source driving signals are constant in the non-display period.

6. A driving device for driving a touch sensitive display device, the touch sensitive display device comprising a substrate, a plurality of pixel units, a touch panel and a plurality of touch sensors, displaying a frame of a video and detecting at least one touch point per vertical scanning period, the driving device comprising:
a display driving module, comprising:
a gate driver, coupled to the plurality of pixel units, for generating a plurality of scanning impulses according to a synchronization signal in a display period of the vertical scanning period to indicate a frame updating sequence of the plurality of pixel units;
a source driver, coupled to the plurality of pixel units, for generating a plurality of source driving signals according to frame data in the display period to indicate color intensities of the plurality of pixel units; and
a controller, for generating an activation signal to indicate a non-display period of the vertical scanning period; and
a touch driver, coupled to the controller and the plurality of touch sensors, for generating a plurality of touch scanning impulses according to the activation signal in the non-display period to trigger the plurality of touch sensors.

7. The driving device of claim 6, wherein the non-display period is a forward edge period of the vertical scanning period, a backward edge period of the vertical scanning period or a union of the forward edge period and the backward edge period.

8. The driving device of claim 6, wherein the display driving module further comprises a common driver, coupled to the substrate, for providing a common voltage sent to the substrate according to a common synchronization signal, wherein the common voltage is constant in the non-display period.

9. The driving device of claim 6, wherein the plurality of pixel units are arranged as a first matrix on the substrate, and the plurality of touch sensors are arranged as a second matrix on the touch panel.

10. The driving device of claim 6, wherein the plurality of scanning impulses and the plurality of source driving signals are constant in the non-display period.

11. A touch sensitive display device for displaying a frame of a video and detecting at least one touch point per vertical scanning period, the touch sensitive display device comprising:
a panel module, comprising:
a display panel, comprising:
a substrate; and
a plurality of pixel units, arranged as a first matrix on the substrate, each corresponding to an element of the first matrix; and
a touch panel, stacked upon the display panel, comprising:
a plurality of touch sensors, arranged as a second matrix, for detecting the at least one touch point according to the plurality of touch scanning impulses in a non-display period of the vertical scanning period to generate a plurality of response impulses; and
a driving device, comprising:
a display driving module, comprising:
a gate driver, coupled to the plurality of pixel units, for generating a plurality of scanning impulses according to a synchronization signal in a display period of the vertical scanning period to indicate a frame updating sequence of the plurality of pixel units;
a source driver, coupled to the plurality of pixel units, for generating a plurality of source driving signals according to frame data in the display period to indicate color intensities of the plurality of pixel units; and
a controller, for generating an activation signal to indicate the non-display period; and
a touch driver, coupled to the controller and the plurality of touch sensors, for generating the plurality of touch scanning impulses according to the activation signal in the non-display period to trigger the plurality of touch sensors.

12. The touch sensitive display device of claim 11, wherein the non-display period is a forward edge period of the vertical scanning period, a backward edge period of the vertical scanning period or a union of the forward edge period and the backward edge period.

13. The touch sensitive display device of claim 11, wherein the display driving module further comprises a common driver, coupled to the substrate, for providing a common voltage sent to the substrate according to a common synchronization signal, wherein the common voltage is constant in the non-display period.

14. The touch sensitive display device of claim 11 further comprising a touch processor, coupled to the plurality of touch sensors, for determining the at least one touch point according to the plurality of response impulses.

15. The touch sensitive display device of claim 11, wherein the plurality of scanning impulses and the plurality of source driving signals are constant in the non-display period.
